(19) United States
(12) Patent Application Publication
(10) Pub. No.: US 2009/0126760 A1
(43) Pub. Date: May 21, 2009

(54) SYSTEM FOR CLEANING A SURFACE USING CROGENIC AEROSOL AND FLUID REACTANT

(75) Inventors: Souvik Banerjee, Fremont, CA (US); Ramesh B. Borade, Livermore, CA (US); Werner Brandt, Castro Valley, CA (US)

Correspondence Address: BOC, INC., 575 MOUNTAIN AVE, MURRAY HILL, NJ, 07974-2064, US

(73) Assignee: BOC, INC., Murray Hill, NJ (US)

(21) Appl. No.: 11/793,647

(22) PCT Filed: Apr. 19, 2005
(86) PCT No.: PCT/US2005/013431

§ 371 Date: Jan. 12, 2009

Related U.S. Application Data
(60) Provisional application No. 60/643,201, filed on Jan. 12, 2005.

(51) Int. Cl. B08B 3/10

(52) U.S. Cl. 134/1; 134/105; 134/99.1; 134/103.2; 134/103.3; 134/95.1; 134/95.2; 134/61; 134/19

(57) ABSTRACT

An apparatus and method are provided to treat for example a semiconductor wafer substrate wherein a delivery means for heat, a cryogen, and a fluid chemical reactant, is disposed in a chamber in which the substrate is disposed for at least one surface of the substrate to be cleaned in the chamber. The chamber may also consist of a plurality of stations for chemically treating, providing cryogen to the substrate to effect such cleaning and heating. Air is provided in the chamber in a laminar flow substantially parallel to the surface being treated to remove displaced material from the surface and prevent redeposition of the material on the substrate surface.

### CROSS REFERENCE TO RELATED APPLICATIONS

This application claims priority from PCT Patent Application Serial No. PCT/US05/13431, filed Apr. 19, 2005, which claims priority to U.S. Provisional Application Ser. No. 60/643,201, filed Jan. 12, 2005.

### BACKGROUND OF THE INVENTION

The invention relates to apparatus and systems for cleaning and removing foreign particulate matter and contaminants from surfaces of substrates, such as those of semiconductor wafers or integrated circuits.

Surfaces of objects may become contaminated with a variety of foreign materials or contaminants during processing or use. By way of example, surfaces of substrates, such as semiconductor, metal, dielectric, and other surfaces on substrates, such as semiconductor wafers or integrated circuits, may become contaminated with particulate contaminants, ionic contaminants, and homogeneous contaminants, such as films, during processing. Precision cleaning of these surfaces calls for the removal of all such contaminants to the extent desired or required.

Cryogenic cleaning systems and methods are known to remove various undesirable materials or contaminants from surfaces. By way of example, there are cryogenic cleaning systems that use a stream of cryogenic carbon dioxide (CO₂) gas and/or other gas or gases, such as argon and/or nitrogen, to physically dislodge contaminants from a surface. While such physical systems have been employed in the removal of some particulate contaminants from surfaces, such have not proved capable of adequately or completely removing substantially small particles, ionic contaminants, or homogeneous contaminants, such as films, from these surfaces.

### SUMMARY OF THE INVENTION

The present invention provides for, among other features, an apparatus and method for treating a substrate such as for example a semiconductor wafer, and includes:

An apparatus for treating a substrate, which includes a chamber; and delivery means for heat and at least one selected from the group consisting of a cryogen, a fluid reactant and combinations thereof, disposed in the chamber for delivering treatment to at least one surface of the substrate.

An apparatus for treating a substrate, which includes delivery means for heat, a cryogen and a fluid treatment, the delivery means disposed in a chamber in which the substrate is disposed for treatment to at least one surface of the substrate.

An apparatus for treating a substrate, which includes delivery means for heat and a cryogen, the delivery means disposed in a chamber in which the substrate is disposed for treatment to at least one surface of the substrate.

An apparatus for treating a substrate, which includes delivery means for heat and a fluid reactant, the delivery means disposed in a chamber in which the substrate is disposed for treatment to at least one surface of the substrate.

A method for treating a substrate, which includes disposing the substrate in a chamber; and providing heat and at least one selected from the group consisting of a cryogen, a fluid reactant and combinations thereof in said chamber to at least one surface of the substrate to be treated.

A method for treating a substrate, which includes disposing the substrate in a chamber; and providing heat, a cryogen and a fluid reactant in said chamber for treatment to at least one surface of the substrate to be treated.

A method for treating a substrate which includes disposing the substrate in a chamber; and providing heat and a cryogen in the chamber in which the substrate is disposed for treatment to at least one surface of the substrate.

A method for treating a substrate, which includes disposing the substrate in a chamber; and providing heat and a fluid reactant disposed in the chamber in which the substrate is disposed for treatment to at least one surface of the substrate.

Other features of the invention include the wafer or object to be treated, such as cleaned, to be disposed either horizontally, vertically or in any other orientation during the cleaning operation. Airflow with respect to the wafer will be substantially parallel to the wafer orientation. The wafer can be heated to temperatures of 350° C. or cooled to −50° C. during the cleaning operation. The heating can be done with hot gases flowing through a nozzle or infrared lamps or a platen. The cleaning will include use of a cryogenic nozzle and a chemical delivery nozzle to deliver chemicals either in liquid or vapor state. The liquid or vapor can also be heated to a temperature of up to 100° C. during or prior to delivery of cryogen and/or chemicals. A means of enhancing the reactivity of gases of vapor delivered by a nozzle is also provided and may include ultraviolet (UV) or other electromagnetic radiation. All of these features are preferably provided in single chamber; i.e. the same chamber in which the substrate is disposed for cleaning.

A chemical chamber designated as a chemical station is also provided and includes: The wafer in the chamber undergoing cleaning with fluids, rinsing with deionized (DI) water or organic solvents, and drying with nitrogen (N₂) or isopropyl alcohol (IPA). Dispensation of chemistry may be either in liquid or vapor phase for cleaning. The chemistries in this chamber do not necessarily have to be solvent-based, and can be aqueous-based as well, since humidity control in the chamber is not an issue. The wafer can be rotated up to 3000 revolutions per minute (rpm) during chemistry treatment or thereafter. The wafer can be heated up to 150° C. during chemical treatment to aid in reaction or alternately, the chemicals can be heated. The wafer can be transported between separate treatment stations in communication with each other at the chamber or in communication with a transport assembly for cleaning in different sequences. Substrate rotation can occur during, prior to, or after cleaning in the cryogenic aerosol chamber. The substrate can be rotated up to 500 rpm, but preferably in the range of 50-100 rpm. These and various other aspects, features and embodiments of the present invention are further described herein.

Heating of the wafer compromises the surface adhesion and integrity of the contaminants to be physically removed by a cryogen fluid. This is particularly so where a multiplicity of contaminants form, in effect, a layer of unwanted matter which must be removed from the substrate surface.

### BRIEF DESCRIPTION OF THE DRAWINGS

A detailed description of various aspects, features and embodiments of the present invention is provided herein with reference to the accompanying drawings which are briefly described below. The drawings are illustrative and are not necessarily drawn to scale. The drawings illustrate various aspects or features of the present invention and may illustrate one or more embodiment(s) or example(s) of the present invention in whole or in part. A reference numeral, letter, and/or symbol that is used in one drawing to refer to a particular element or feature may be used in another drawing to refer to a like element or feature, unless otherwise indicated.

FIG. 1 is a view partially in cross-section showing a system for treating, cleaning or otherwise, a substrate according to the invention.

FIG. 2 shows of certain features which may be used in a system shown in FIG. 1.

FIG. 3 is a view of another embodiment of a system according to the invention.

FIG. 4 is a view of another embodiment of a system according to the invention.

FIG. 5 is a view of still another embodiment of a system according to the invention.

FIG. 6 is a view of still another embodiment of a system according to the invention.

FIG. 7 is a view partially in cross-section of still another embodiment of a system according to the invention.

### DESCRIPTION OF THE INVENTION

The present invention is directed to a system for treating, such as cleaning, a substrate and in particular, a surface of a substrate using a combination of chemical and physical means. By way of example, the system may be used to clean a surface of a substrate, such as a surface of a semiconductor substrate or an integrated circuit (hereinafter referred to, for example, as “substrate” or “surface”).

The system includes a chemical or chemical composition as a reactive fluid, such as a reactive liquid and/or vapor, that is provided to the substrate to react with undesirable foreign material and/or a contaminants at the substrate surface and which is targeted for removal from the surface. The reactive fluid treats the surface and contaminants thereon to facilitate surface preparation for subsequent physical removal of the contaminants from the surface.

The system also includes a stream of cryogenic fluid, such as CO₂, argon, and/or nitrogen, or any other cryogenic aerosols, either alone or in combination with each other, that is provided to the substrate and capable of physically disrupting material that is to be removed from the surface. In effect, the reactive fluid weakens or breaks-down the contaminate matter, thereby facilitating the removal under disruption by the mechanical action of the cryogenic stream.

The present invention also includes a method for cleaning a surface using a combination of chemical and physical means, such as a method for the precision cleaning of a surface of a semiconductor substrate or an integrated circuit.

The present invention also provides for treatment of the substrate by application of heat, a reactive fluid and a cryogen to the substrate in a common chamber.

In the description of the invention herein, it will be understood that a word appearing in the singular encompasses its plural counterpart, and a word appearing in the plural encompasses its singular counterpart, unless implicitly or explicitly understood or stated otherwise. Further, it will be understood that for any given component described herein, any of the possible alternatives listed for that component, may generally be used individually or in combination with one another, unless implicitly or explicitly understood or stated otherwise. Additionally, it will be understood that any list of such alternatives is merely illustrative, not limiting, unless implicitly or explicitly understood or stated otherwise.

Further, it will be understood that the system and method described herein for cleaning a substrate may be used in connection with any substrate requiring cleaning or precision cleaning. The substrate may be any substrate that has a surface that comprises a semiconductor material, a metal material, or a dielectric material, merely by way of example. Thus, while a term such as “semiconductor,” “metal,” “dielectric,” may be used in relation to a surface of a substrate, such as a semiconductor substrate or an integrated circuit, it will be understood that the cleaning system and method described herein may be used in connection with any suitable surface of a substrate. Further, while a term such as “semiconductor” or “integrated circuit” may be used in relation to a substrate, it will be understood that the cleaning system and method described herein may be used in connection with any suitable substrate. Merely by way of example, a suitable substrate may be a hard disk medium, an optical medium, a GaAs medium, and a suitable surface may be any surface of any such substrate, such as any film or any layer on any such substrate.

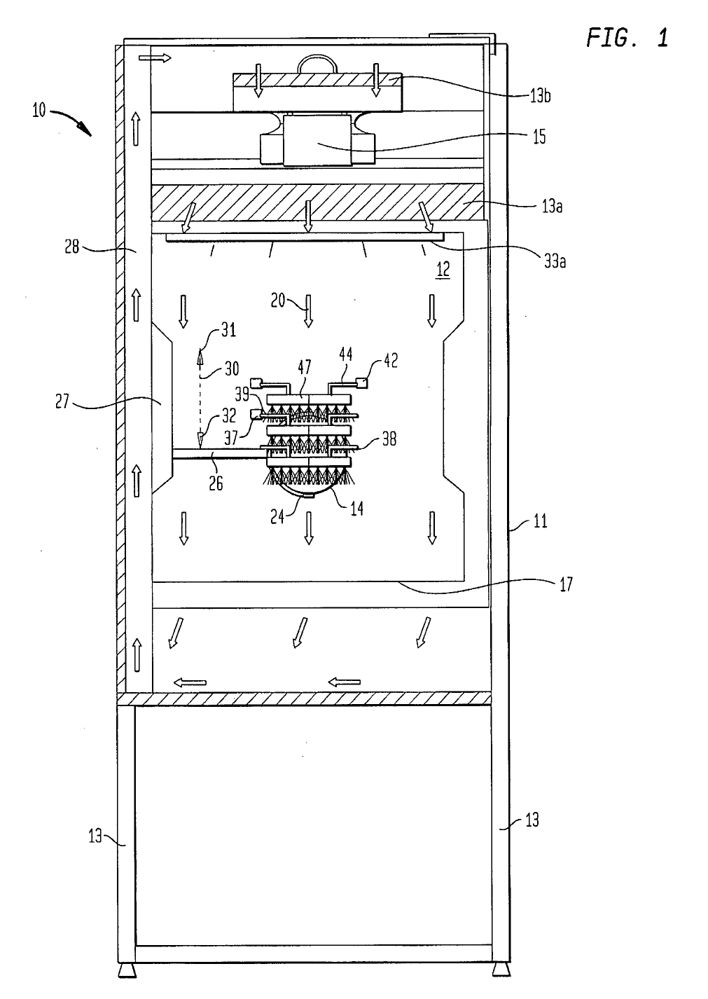

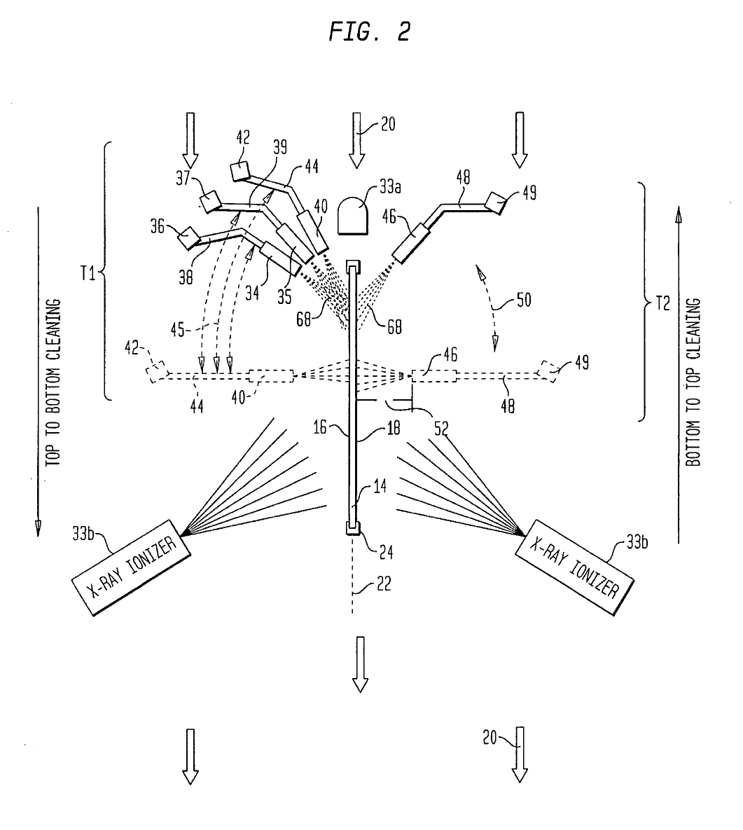

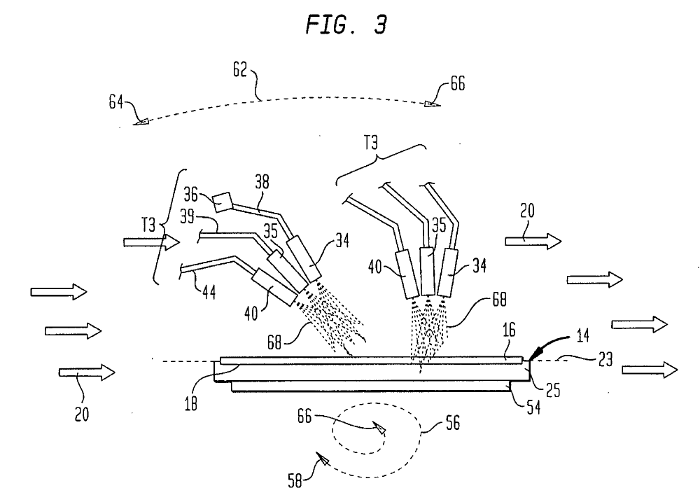

An embodiment of the system of the invention is shown generally at 10 and is now described with reference to FIGS. 1-3. The system 10 may also be referred to as a tool. FIGS. 1 and 2 depict the vertical orientation of a substrate, while FIG. 3 shows the substrate in horizontal configuration.

The system 10 includes a housing 11 containing a cleaning chamber 12 in which a substrate 14 may be disposed, such that a surface of the substrate, such as a front surface 16 and/or a back surface 18, that is targeted for cleaning is substantially parallel, and preferably parallel, to the general direction of airflow as represented by arrows 20, through at least the chamber portion 12 of the system 10. The housing is supported on an underlying surface by legs 13. A false floor or grid 17 is disposed at the bottom of the chamber 12 and through which the airflow, as represented by arrows 20, may pass. Thus, if the airflow is vertical then the substrate 14 is held vertically as shown in FIG. 2, whereas the substrate 14 is held horizontally for horizontal airflow as in FIG. 3. Regardless of the substrate 14 orientation, airflow 20 is preferably parallel to the substrate surface being treated.

By way of example, the substrate 14 of a more or less circular shape, such as a semiconductor wafer, may be disposed as shown in FIGS. 1-3 such that its diameter extends along a vertical axis 22 of a substrate holder 24, or a horizontal axis 23 of the substrate holder 25, with the front surface 16 and back surface 18 are substantially parallel to the direction of airflow 20. The relation between the orientation of the surfaces 16, 18 to the airflow 20 is important so that contaminants removed from the substrate surface are not permitted to be redeposited on the substrate. The system 10 may be designed to accommodate a variety of substrates of a variety of sizes and shapes, such as a circular wafer or disk having a diameter of from about 100 mm to about 300 mm, merely by way of example, or a square-shaped glass substrate with each side up to 150 mm in length, such as photomask. The substrate 14 may be held within the chamber 12 by any suitable means, such as with a substrate holder 24, 25 or a wafer clamp. The holders 24, 25 are connected to a movable arm 26. The arm 26 is supported for movement by support member 27.

In FIGS. 1-3, the front surface 16 has undergone extensive processing wherein particulate matter is adhered to the surface and is resistant to displacement and removal by a physical force alone such as a cryogenic stream. The back surface 18 has undergone processing that will only require physical force, such as a cryogenic stream to remove any contaminates, particulate matter, etc., from the surface 18.

Another embodiment of the system is shown in FIG. 3, and such embodiment is adapted to rotate the substrate 14 in a substantially horizontal disposition, and preferably in a horizontal disposition, from zero to 360 degrees in any suitable manner, such as clockwise or counterclockwise, respectively, as represented by a dotted line 56 and associated clockwise arrow 58 or counterclockwise arrow 66, respectively. Such rotation may be performed before a cleaning process, during a cleaning process, between sequential cleaning processes in a series of cleaning processes, and/or at various times, as desired, and may be facilitated or accomplished using a substrate holder 25 of sufficient construction or design for such rotation. Any such rotation may be performed manually, mechanically, robotically, automatically, or via computer. In a preferred embodiment, a rotational position of the substrate 14 may be selected (in terms of degree of rotation, for example) by a user of the system 10 via computer software and computer hardware (not shown) that are in operable communication with the cleaning system and its components, such as any substrate-rotation means. Preferably, any such software employs user-friendly selection means, such as menus or recipes.

Referring again to the embodiment where the substrate is oriented substantially vertically as in FIGS. 1 and 2, the substrate 14 may be moved by the arm 26 in an upward or downward direction within the chamber 12, as represented by a dotted line 30 and associated arrows 31, 32, respectively, representing such movement. Any such movement may be performed before a cleaning process, during a cleaning process, between sequential cleaning processes in a series of cleaning processes, and/or at various times, as desired, and may be facilitated or accomplished using the substrate holder 24 of sufficient construction or design for such movement. Any such movement may be performed manually, mechanically, robotically, automatically, or via computer. In a preferred embodiment, a movement of the substrate 14 in an upward or downward direction may be selected (in terms of distance of movement, for example) by a user of the system 10 via computer software and computer hardware (not shown) that are in operable communication with the cleaning system and its components, such as any substrate-movement means. Preferably, any such software employs user-friendly selection means, such as menus or recipes.

The airflow 20 through the chamber 12 of the system 10 is from about 100 linear feet per minute (lfpm) to about 600 lfpm, and is preferably substantially laminar at 250 lfpm, and preferably highly laminar. The airflow 20 is important to control removal of contaminants from the substrate so as to avoid redeposition of contaminants upon the substrate 14 after it is treated or cleaned. The airflow 20 is provided by a blower assembly 15 in FIG. 1 forcing air through filter assembly 13a. A filter assembly 13b may also be used and through which the airflow 20 is drawn to be recirculated. The filter assemblies 13a, 13b filter an atmosphere in the chamber of particulate matter, etc. A plenum 28 is provided along a side of the chamber 12 to facilitate channeling the airflow 20. The debris cleaned from the substrate is entrained in the airflow 20 for being trapped in the filters 13a, 13b. Nitrogen is preferred as the airflow 20 medium, although other gases may be used for the airflow 20. The airflow 20 is substantially parallel to the surface 16, 18 of the substrate to be cleaned, and preferably parallel.

The system 10 and the airflow 20 therein may be designed to provide a cleaning environment of a standard that is suited to a particular application. For example, the system 10 and the airflow 20 therein are preferably sufficient for maintaining a Class I cleaning environment, and are sufficient for applications that require a cleaning environment meeting that standard. The system 10 operates at least at ambient pressure and preferably slight higher than ambient to prevent backflow of external atmosphere into the system.

The system shown for vertical substrate orientation as in FIGS. 1 and 2 includes a first cleaning assembly T1 and a second cleaning assembly T2. T1 is adapted to provide heating, a chemical reactant and a cryogenic stream to, for example, front surface 16 of the substrate 14. The assembly T2 is adapted to provide a cryogenic stream to the opposed or back surface 18 of the substrate 14. The system 10 may employ a variety of means for heating/cooling a substrate 14 and an area surrounding the substrate within the chamber 12. Such heating methods include, but are not limited to, direct heating by platen, hot gas flow or indirect heating by lamps, i.e. conduction, convection or radiation. By way of example, a nozzle 34 may be employed to supply a heating/cooling medium, such as a hot/cold gas from a source 36 thereof such as for example nitrogen, clean dry air (CDA), carbon dioxide (CO₂), Argon (Ar), Helium (He), Oxygen (O₂), combinations thereof, and other gases known for heating and refrigeration. The temperature range is from −50° C. to 350° C. and preferably between 30° C. to 300° C. In such an embodiment, the nozzle 34 and the source 36 are in operable communication with one another via a conduit or passage 38, as shown in FIG. 2.

FIG. 3 shows another embodiment of the system of the invention. Further by way of example, a platen 25 or stage may be used to supply heat to the substrate 14 and an area surrounding the substrate within in the chamber 12 as shown in the horizontal substrate orientation in FIG. 3. In such an embodiment, the platen 25 is in operable communication with a heat source 54, such as an electrical heat source. It will be understood that while the platen 25 is located below the substrate 14, the platen 25 may be otherwise located in the chamber 12, as suitable. The substrate 14 is heated by the heat conducted from the heat source 54 through the platen 25. Heating of the substrate helps enhance particulate removal capability and facilitates chemical disruption of the contaminates, depending upon the chemicals employed.

As shown in FIG. 3, the substrate 14 to be cleaned at the front surface 16 thereof, is disposed substantially horizontally to be acted upon by the cleaning assembly T3. The air flow 20 is again of a laminar flow and substantially parallel, preferably parallel, with respect to the surface 16 to be cleaned. As indicated above with the other embodiment, the air flow 20 is important to prevent contaminates and particulate matter which are dislodged and removed from the surface 16 from being redeposited during the cleaning process provided by the system.

The substrate 14 is supported on the platen 25 for exposure of the surface 16 for treatment. A heater element 54 is disposed for contacting the platen 25 to provide heat thereto. The platen 25 is adapted for rotational movement as indicated by the broken line 56, such rotation indicated by arrows to be in a clockwise direction 58 or a counterclockwise direction 66. Should the substrate heater 54 be used in connection with the platen 25, the heater is similarly adapted to rotate with respect to the platen 25. Accordingly, the platen 25 is constructed and arranged to both support and retain the substrate 14 during a rotation of the platen 25. The substrate heater 54 may also be embedded in the platen 25. The substrate 14 may also be heated by heated convection currents and/or a radiation device (not shown). The heater 54 in contact with the platen 25 provides for heating of the substrate 14 and in particular, via the back surface 18 of the substrate 14.

The cleaning assembly T3, consisting of the nozzle 34 for applying heating, nozzle 35 for providing the cleaning or chemical reactant, and the CO2 nozzle 40 are adapted to be moved for disposition at select locations with respect to the wafer 14, as shown by the broken line 62 in either of the directions 64, 66. The assembly T3 adapted for such select movement enables the user to provide with more particularity and accuracy the treatment and cleaning necessary to eliminate the contaminate and particulate matter from the surface 16. As with the embodiment discussed above, a spray pattern 68 deployed by the nozzles 34, 35, 40 results in an angle of incidence with respect to the contacting of the sprays 68 on the surface 16, depending upon the position of the assembly T3. The chemical delivered from the nozzle 35 can be in either a liquid or vapor state. Alternatively, the platen 25 may be moved for positioning of the substrate with respect to the assembly T3.

Still referring to FIG. 3, means for heating and/or cooling (“heating/cooling”), such as nozzle 34, or platen 25, may be used alone or in any combination with each other to bring the substrate 14 to a desired temperature, such as from about 30° C. to about 350° C. Any such heating/cooling means such as the nozzle 34, is positioned in sufficient proximity to the substrate, such at a distance of from about 2 mm to about 50 mm, for such heating. The heated platen 25 is preferably in contact with the substrate 14 or not more that 5 mm therefrom, to effect heating of the substrate 14, and known positioning means may be used for this purpose. Any such heating means may be adjusted or controlled (in terms of on, off, positioning, and level of heating, for example) manually, mechanically, robotically, automatically, or via computer. In a preferred embodiment, any such heating means may be controlled by a user of the system 10 via computer software and computer hardware (not shown) that are in operable communication with the cleaning system and its components, such as any heating means or positioning means therefor. Preferably, any such software employs user-friendly control means, such as menus or recipes.

The system 10 and its components are of a construction sufficient to handle temperatures within the system that are employed for the heating of the substrate 14. By way of example, any of the system 10 and its various components may be composed of materials that are compatible with system temperatures, such as metals and high-temperature plastics.

Referring to FIGS. 2 and 3, the cleaning assemblies T1 and T3 include a chemical delivery nozzle 35, heating/cooling means such as nozzle 34, and a CO2 nozzle 40. The chemical delivery nozzle 35 is provided facing the front surface 16 of the substrate 14. The chemical or chemicals delivered therefrom may include by way of example ethanol, acetone, ethanol-acetone mixtures, isopropyl alcohol, methanol, methyl formate, methyl iodide, ethyl bromide, acetonitrile, ethyl chloride, pyrrolidine, dimethylsulfoxide, individually or in any combination thereof.

The chemical delivery nozzle 35 is connected to a chemical source 37 by a conduit or pipe 39. A CO2 nozzle 40 is connected to a CO2 source 42 by conduit 44. The nozzle 35 is constructed and arranged to face the front surface 16 of the substrate 14. The nozzle 40 is connected to CO2 source 42 by conduit 44. The nozzle 40 is constructed and arranged to face the front surface 16 of the substrate 14. The nozzles 34, 35, 40 are adapted to be movably disposed to a select position with respect to the substrate 14, as shown by the broken lines 45. In a preferred embodiment, the sources 36, 37, 42 and the conduits 38, 39, 44 are adapted to move with their respective nozzles 34, 35, 40. Although the nozzles can be displaced, it is the substrate 14 that is vertically or horizontally moved to expose, for example, the front surface 16 in FIGS. 2 and 3, and the back surface 18 in FIGS. 1 and 2 to the cleaning assembles T1, T3.

The chemical cleaning nozzle 35 may be employed to supply the cleaning medium, in the form of liquid or vapor referred hereinafter as fluid, such as a reactive cleaning agent or fluid, or a physical cleaning agent or fluid, from the source 37 thereof. The nozzles 34, 35, 40 of T3 can provide broad or single point sprays.

The chemical nozzle 35 for the cleaning medium may be used alone or in any combination and may be adjusted or controlled (in terms of on, off, positioning, and force or flow rate of cleaning medium, for example) manually, mechanically, robotically, automatically, or via computer. In a preferred embodiment, the chemical nozzle 35 may be controlled by a user of the system 10 via computer software and computer hardware (not shown) that are in operable communication with the cleaning system and its components, such as any medium-supply means. Preferably, such software employs user-friendly control means, such as menus or recipes. As mentioned above, means 34 for supplying a heating medium and the supply means 35 for supplying a chemical medium may take the form of nozzles.

As shown in FIG. 1, another nozzle 46 is disposed to provide CO2 to the back surface 18 of the substrate 14 when same is in an orientation providing access to the back surface 18. By way of example, the nozzle 46 may be of a construction sufficient to deliver a spray of the fluid medium from a single point as shown in FIG. 2, which may be referred to as a “point-spray nozzle.” Alternatively, a nozzle 47 may be of a construction sufficient to deliver multiple sprays of the fluid medium from multiple points, as shown in FIG. 1, which may be referred to as a “broad-spray nozzle.” The broad-spray nozzle 47 may comprise an array of point-spray nozzles. The system 10 may be provided with a point-spray nozzle, a broad-spray nozzle, or any combination thereof, such that a user may select any of same to use in a particular application. Further, when the system 10 employs multiple nozzles of whatever type, the nozzles may be activated singularly, simultaneously, consecutively, in a time pattern or sequence, in a spatial pattern or sequence, or any suitable combination thereof.

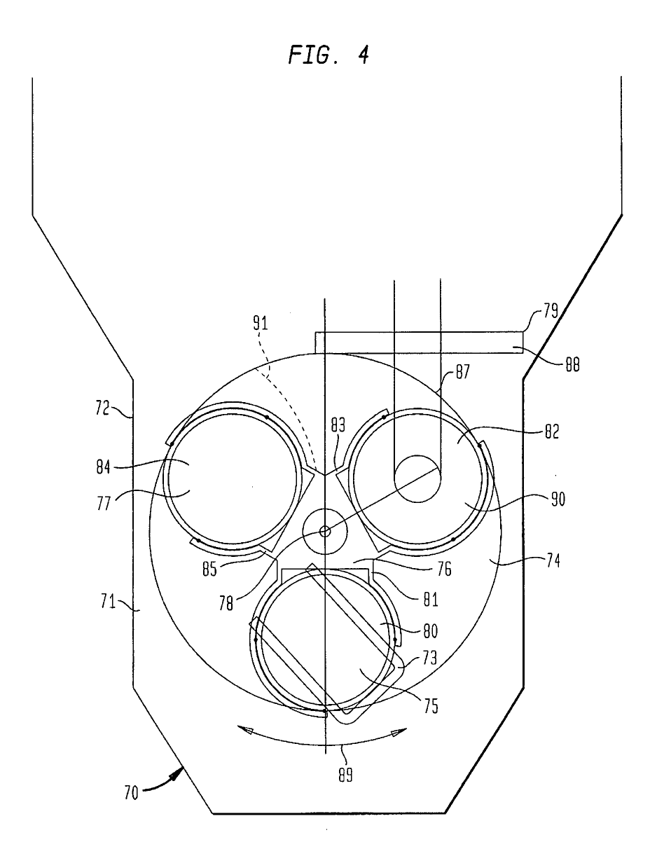

In addition, all of the nozzles and assemblies T1, T2, T3 in FIGS. 1-3, regardless of arrangement, may be used in the embodiments shown in FIGS. 4-7, and may be constructed in a fixed placement, either alone or in any combination with each other, but adapted to be selectively placed with respect to the wafer holders or platens 24, 25. The nozzles can be actuated and shut down by a solenoid valve (not shown) to provide for a select sequence of nozzle use. The nozzles of cleaning assemblies T1, T2, T3 can be selectively positioned through, for example, a 90° arc.

The system 10 is for the cleaning of one or another side or surface of a substrate or multiple sides or surfaces of a substrate 14, simultaneously, concurrently, or at different times. It will be understood that while the substrate 14 shown in FIGS. 1-3 includes a front side or surface 16 and a back side or surface 18, substrates of different types, such as those constructed and arranged with differently sized and shaped sides or surfaces, may be cleaned by the system 10, given the system's capacity for flexible and variable positioning of one or more of the nozzle(s) 34, 35, 40, 46, or 47 as described above.

The CO2 nozzle 46 is connected to a conduit or pipe 48 in fluid communication with a CO2 supply or source 49. The CO2 supply or source 49 is preferably highly pure CO2. The nozzle 46 is adapted to be positioned, as indicated by broken line 50, to a select position with respect to the substrate 14.

The nozzles 40, 46 for supplying a CO2 medium are positioned at a suitable distance 52, for example, from the surface 16, 18 such that the medium contacts the surface. The distance 52 from a point from which the subject medium exits the nozzle 40, 46 to the respective surface 16, 18 may be of from about 2 mm to about 50 mm, by way of example. A suitable positioning means, such as the substrate holder 24, may be used for this purpose. The nozzle 34 for supplying a heating medium and the nozzle 35 for supplying a chemical or cleaning medium may be oriented in such a way as to supply the medium at an angle of incidence relative to a surface to be cleaned. By way of example, an angle between the spray of a cleaning medium, as represented by a dotted line 68, and the surface 16 or 18 of the substrate 14, is about 30 degrees as shown in FIG. 2. The nozzles 34, 35 and 40 may be oriented to supply the medium at any suitable angle of incidence, such as from zero degrees to about 90 degrees.

Although CO2 nozzles 40, 46 are constructed and arranged to be selectively positioned with respect to the surfaces 16, 18, various orientations of the nozzle 34, 35 may be used to achieve a desired angle of incidence. By way of example, the nozzles 34, 35 may be moved to a suitable angular position relative to the vertical axis 22 of the holder 24, or the horizontal axis 23 of the platen 25, such as up to about 90 degrees to achieve a desirable angle of incidence, as is shown for example in FIG. 2.

For example, as shown in FIG. 2, the nozzles 34, 35 may be moved in an upward or a downward direction, such as along arcuate paths, as represented by the dotted line 45. Thus, the system 10 may be designed or manipulated to supply a heating medium or a cleaning medium in a direction that is from substantially parallel to substantially perpendicular to the direction of airflow 20 of the system. It is preferred that the heating medium or a cleaning medium moves in a direction that does not impede the airflow 20 of the system 10.

As described herein, the nozzles 34, 35, 40, 46 and 47 for supplying the subject medium within the chamber 12 may be adjusted or controlled in a variety of ways. By way of example, adjustments or controls as to nozzle selection, nozzle activation, nozzle-to-substrate distance, angular positioning of a nozzle to provide a select angle of incidence, are contemplated. Any such adjustment or control may be carried out manually, mechanically, robotically, automatically, or via computer. In a preferred embodiment, any such adjustment or control is carried out by a user of the system 10 via computer software and computer hardware (not shown) that are in operable communication with the cleaning system and its components for supplying a subject medium and any positioning means therefor. Preferably, any such software employs user-friendly control means, such as menus or recipes.

In the system 10, the nozzles 40, 46, 47 are used to supply a medium that is sufficient to physically act on a material to be removed from the surfaces 16, 18 of the substrate 14. The medium may be a cryogenic agent or fluid, such as a cryogenic gas comprising carbon dioxide, argon, nitrogen, or any suitable combination thereof, by way of example, and the material to be removed from the surfaces 16, 18 may be an undesirable material or a contaminant, such as an ionic material, a relatively inhomogeneous material, such as a particulate material, and/or a relatively homogeneous material, such as a film.

In embodiments in which the multiple cleaning assemblies T1, T2, T3 are employed, such multiple assemblies may be arranged in a nested or spatial arrangement, array, or pattern relative to one another, such that the respective agents may be delivered in a spatial arrangement, array, pattern or sequence, in a time pattern or sequence, or any combination thereof.

The system 10 and its components are of a construction sufficient to handle the cleaning medium or media, such as a reactive agent or agents and a cryogenic agent or agents, within the system that are employed in the cleaning of the substrate 14. By way of example, the system 10 and its various components may be composed of materials that are compatible, such as for example stainless steel, Teflon®, glass, etc., with any reactive agent or cryogenic agent employed, such as those described further herein.

When the system 10 is used to clean a substrate, an undesirable charge such as an electrostatic charge, may be present or may develop in the cleaning chamber 12. By way of example, such a charge may develop by way of tribocharging that may be caused by the flow of a cryogenic agent or fluid from the supply means 42 across the surface of the substrate 14. The development of such a charge may be aided by low humidity conditions such as for example, dewpoint less than 20° C. in the cleaning chamber 12. Thus, the system 10 may comprise, and preferably does comprise, means for mitigating or neutralizing an undesirable charge that may be present in the cleaning chamber 12. Any such mitigating or neutralizing means may include: means for corona ionization, such as a corona ionization bar; means for polonium ionization, such as a polonium nozzle; means for x-ray or photon ionization, such as an x-ray or a photon ionizer; means for electrically grounding the substrate 14; and any combination thereof.

By way of example, a corona ionization and/or a polonium ionization bar or nozzle, each as schematically represented by a charge dissipation or neutralizing means 33a in FIG. 2, may be located in the chamber 12. Further by way of example, an x-ray and/or photon ionizer 33b may be located within or outside the chamber 12 if a means for passing x-ray or photon irradiation, such as one or more radiation-transparent window(s), is provided in one or more wall(s) of the chamber 12, for example. Any such means 33a, 33b may be directed at the substrate 14 as shown in FIG. 2 to mitigate or neutralize an electrostatic charge on or in of the substrate 14. An x-ray or a photon ionizer, such as that distributed by Ion Systems, Inc. of Berkeley, Calif., may be used. Still further by way of example, a means (not shown) for electrically grounding the substrate 14 may be in electrical communication with the substrate 14. Such means may be in the form of a grounded electrical wire that is in electrical communication with the substrate holder 24 that is, in turn, in electrical communication with the substrate 14. The neutralizing means 33a is preferably proximate to the CO2 nozzles 40. The corona ionizer is preferably connected to be proximate to the filter 13a or suspended therefrom as shown in FIG. 1.

An active feedback mechanism may also be used in connection with electrostatic discharge (ESD) mitigation to bring the substrate being cleaned or processed back to zero potential.

As mentioned above, the system 10 employs multiple cleaning media, one of which comprises a reactive agent or fluid that has a high vapor pressure, as further described below. The reactive fluid is capable of reacting with a material that is targeted for removal from the surface 16, of the substrate 14, such as an organic or inorganic material or contaminant, for example. As described above, the reactive fluid is supplied to the surface 16 of the substrate 14 via supply means such as nozzle 35, in an aerosol, spray, stream or jet in a cleaning process according to the present invention.

In some applications, a substrate may be processed in an “upstream” process that precedes a cleaning of the substrate according to the present invention. In such an upstream process, the substrate may be exposed to an aqueous agent or an aqueous environment. In the subsequent cleaning of the substrate 14 according to the present invention, the reactive fluid may remove water from the surface 16 of the substrate 14, and thereby facilitate further cleaning, as further described herein. The bulk water can also be removed by rotating or spinning the wafer about its central axis in the chamber 12 as with the embodiment of FIG. 3.

According to the invention, the reactive fluid or chemical deployed from the nozzle 35 may reduce if not eliminate a van der Waals force that exists between contaminate material to be removed from the surface 16, of the substrate 14 and that underlying surface, and thereby facilitate the material's removal, as further described herein. Further, the reactive fluid may react with an organic material or contaminant on the surface 16 of the substrate 14. A suitable reactive fluid may be chosen according to the organic material or contaminant contemplated or targeted for removal. Various reactive fluids are known to be useful in the dissolution or reaction with various organic materials and contaminants.

The above-described reactive fluid may comprise a liquid that has a high vapor pressure, such as greater than or equal to 5 kPa at 25° C. Merely by way of example, a suitable liquid may include ethanol, acetone, isopropyl alcohol, methanol, methyl formate, methyl iodide, ethyl bromide, acetonitrile, ethyl chloride, pyrrolidine, tetrahydrofuran, or any combination thereof; or non-polar solvents as well. The suitable liquid has a low freezing point, such as a freezing point of less than or equal to 0° C. and preferably a freezing point of less than −10° C. This preferably applies when the chemical is dispensed with nozzle 35 inside the cryogenic chamber 12, and not when dispensed in a separate chemical chamber.

According to the present invention, the reactive or chemical fluid is supplied to the surface 16 of the substrate 14, whereupon it readily evaporates from that surface given its high vapor pressure. As such, there is no need to dry the substrate 14 subsequent to removing the fluid such as by the heating or the spinning of the substrate. According to a preferred embodiment, the reactive fluid is polar, such that dissolution of any organic or inorganic material or contaminant on the surface 16, of the substrate 14 is facilitated. Further, according to a preferred embodiment, the reactive fluid has a low freezing point, such that if any residual fluid remains on the surface 16 of the substrate 14 it will not freeze during a cryogenic cleaning process, as further described herein.

According to an embodiment of the present invention, the reactive fluid may be supplied to the surface 16 at a temperature of less than or equal to about 150° C., such as from about 30° C. to about 80° C. This could be either the temperature of the reactive fluid, the substrate 14, or both. For example, we have found that there are certain advantages to dispensing heated liquid to the substrate 14 at room temperature, or alternatively heating the substrate and dispensing liquid to it which is at room temperature. Merely by way of example, this fluid may be sprayed onto the substrate surface 16, 18 to form a thin layer or a thick film. Preferably, any such layer is at least from about 5 Å to about 10 Å thick.

The reactive fluid covers the surface 16 for from at least one minute and up to about ten minutes, and may be applied to the surface 16 once during any such period, or a plurality of times during any such period, to ensure that the surface remains sufficiently wet. Additionally, the reactive fluid may be applied to the surface 16 while the substrate 14 is rotated at a suitable speed, such as a speed of about 100 revolutions per minute, to ensure that it covers the surface in a sufficiently uniform manner.

The reactive fluid may be sprayed onto the substrate surface 16, 18 using any suitable nozzle, as described above in relation to nozzle 35. A preferred example of a suitable nozzle is a misting nozzle made of Teflon®, such as that often used in a wet bench for spraying deionized water onto a surface of a semiconductor wafer.

In FIG. 4 there is shown a multi-position carousel 70 for handling one or a plurality of substrates 14 for cleaning. The carousel 70 may stand alone or may be positioned in the chamber 12 of the system 10 and exposed to the environment for controlled air flow as discussed above with the foregoing embodiments. Alternatively, the carousel provides it own internal chamber 71 in which the substrate cleaning occurs. The carousel 70 may include a housing 72 and port (not shown) for access to and from the chamber 71. A lift arm or pins 73, actionable at the carousel 70 retrieve wafers at the port for treatment. The arm 73 is adjacent a region 74 in the chamber 71, which is sized and shaped to receive a rotatable platform 76 mounted for rotation about carousel axis 78.

The platform 76 is constructed and arranged with a plurality of platens 80, 82, 84 (collectively “80-84”), each one of the platens 80-84 mounted to a corresponding one of the arms 81, 83, 85 (collectively “81-85”) extending from the platform 76 and which are spaced apart from each other about the platform 76. Each of the platens 80-84 is sized and shaped to receive the substrate 14 for treatment and cleaning. The multiple stations shown in FIG. 4 facilitate the treatment and cleaning of the wafer(s). The processing stations for cleaning remain fixed, while the platens 80-84 are rotated or moved to and from the stations. The stations include a wafer load/unload station 75, a chemical station 77, a cryogen or CO₂ station 79, and heater station 90.

The platform 76 is adapted for selective directional rotation, either clockwise or counterclockwise as indicated by arrow 89, and can be rotated at select speeds depending upon the substrates 14 to be treated. In effect, the construction and arrangement of the components of the carousel 70 provide for at least one or a plurality of substrates 14 to be treated and cleaned on a continuous basis. In addition, the carousel 70 may be provided with a plurality of housings 72, each one of the housings 72 adapted for treatment and cleaning applications conducive to the particular type of substrate 14 being acted upon.

In FIG. 4, the platen 80 is positioned at what is referred to as the entry/exit or load/unload station. The arm 73 is provided to retrieve a substrate 14 from an operator or a conveyor assembly (not shown) transferring the wafer 14 to the region 74.

The housing 72 is provided with a cryogen assembly 88 having one or a plurality of CO₂ nozzles arranged for coaction with the wafer 14. The heater station 90, such as a heater nozzle discussed with respect to the foregoing embodiments, is also provided in the housing 72 for heating the substrate 14. A transport assembly 87 is provided to move the wafer to the assembly 82, or vice versa.

The arm 73 transports the substrate 14 to the load station 80. The platform 76 is rotated to move the platen 80 with the wafer thereon initially to either of the heat station or the chemical station. There may also be provided between the load and chemical stations a wall 91 having an actionable slot adapted to be opened and closed (not shown) to provide and prevent unwanted communication between the chemical and other stations. After the substrate is rotated to the chemical station 84, the slot is closed. The wafer is subjected to chemical treatment from a nozzle disposed at the station to deliver the fluid reactant chemistry. The substrate 14 may itself be rotated about its axis at the station to facilitate spreading the chemistry over the surface of the substrate 14. The substrate 14 and/or the chemistry can be heated to further facilitate chemical reaction in the same station 84. The substrate 14 may also by rinsed with DI water at the station 84, and then further dried.

Thereafter, the platen 80 is rotated from the chemical station to the CO₂ station. Non-aqueous chemistries may also be applied to the substrate at the CO₂ station 82.

The operational steps with respect to FIG. 4 may be in any sequence. That is, after the wafer 14 is loaded onto the platen 80, the platform 76 can be rotated to move the platen 80 to either the chemical station or the heater station for treatment. The platform 76 is first rotated to the chemical station. Accordingly, the platen 80 would be rotated to the heater station while the platen 82 would concurrently be rotated to the wafer load/unload station. After chemical treatment, the platform 76 can be rotated for example clockwise to position the platen 80 to the heater station for heating, or alternatively in lieu of heating, application of CO₂ by the nozzles 88 prior to heating. Thereafter, heating of the substrate can occur. Alternatively, heating 90 of the substrate can occur first prior to use of the nozzles 88 thereafter. After the cryogen station 79, the water can be moved by the platen 82 to the chemical station 77.

Of course, the platform 76 is also adapted to initially rotate the platen 80 in a counter clockwise direction so that the wafer is first heated at the heating station, after which the nozzles 88 can be employed for use on the wafer, or alternatively, the heated wafer can be rotated to the chemical station for chemical treatment after, which the platform 76 can be rotated again in a clockwise direction to bring the platen 80 into position for cryogen or CO₂ application by the nozzles 88.

Therefore, it can be seen that the embodiment of FIG. 4 is constructed and arranged to provide for selective positioning of the wafer when same is loaded onto the carousel. It should be understood that one or a plurality of wafers may be treated with the carousel 70 at the same time.

The chemical reactant is applied to help disrupt adhesion of any particulate matter or contaminants on the surface 16 of the substrate for subsequent removal therefrom.

The reactive fluid can be dispensed in the chemical station to the wafer either prior to or following cleaning at the cryogen station. The fluid in such case is dispensed on the wafer surface through a nozzle made of chemically inert material such as Teflon®. The wafer may be rotated at a speed of up to 2000 rpm, and preferably up to 1200 rpm, during the fluid dispensation to provide a shear force to the contaminants through the reduced boundary layer due to the wafer rotation. During this cleaning step, either the wafer can be heated by heaters embedded in a wafer chuck or platen (as discussed above) to temperature up to 150° C. and preferably up to 80° C., or the fluid delivered heated by in-line heaters (not shown) to such temperature. The fluid dispensed in the chemical chamber for delivery to the wafer is not limited to high vapor pressure. Both aqueous and solvent based chemistries can be used in this chamber for cleaning.

The fluid cleaning provided in this chamber can be from two to ten minutes, afterwhich the wafer is rinsed in the same chamber with DI water flowing through the same nozzle at the chemical station 84. The DI water rinse can be from five seconds up to five minutes during which the wafer is rotated at speed up to 2000 rpm, and preferably up to 1500 rpm. The wafer may or may not be heated during this time.

The wafer may have to be dried before being transported to the cryogen station for cryogenic cleaning. The drying can be done either by spinning the wafer to a speed of up to 3000 rpm, and preferably 2500 rpm, while the wafer is heated to temperatures of up to 80° C. The dried wafer is then transported to the cryogen station by using the arm 73 or rotating the platform 76.

In another embodiment, the wafer either during or after the above drying operation is exposed to hot isopropyl alcohol (IPA) at temperatures of up to 100° C. and preferably up to 80° C. During this operation, the wafer is kept at a temperature below the IPA temperature by more than 10° C. difference. The IPA will in such case condense on the wafer surface providing a thin film of liquid IPA which will help in reducing the force of adhesion of the contaminant particle for ease of subsequent removal by cryogenic means at station 82.

The reactive agent or fluid may be a reactive liquid, as described above with respect to FIGS. 1-3, a reactive gas or vapor, as is now described, or any combination of the two. Hereinafter, merely by way of simplicity or brevity, a reference to reactive gas may encompass a reactive vapor, and a reference to a reactive vapor may encompass a reactive gas, unless otherwise indicated or understood. The reactive fluid may comprise a reactive gas, a reactive vapor, a reactive vapor of a reactive liquid, or any combination thereof, that is capable of reacting chemically with a material that is targeted for removal from a surface 16 of a substrate 14.

As described previously, this reactive fluid is supplied to the surface 16 of the substrate 14 via nozzle 35, such as in an aerosol, a spray, a stream, or a jet, in a cleaning process according to the present invention. The reactive gas or vapor may be allowed to remain in contact with the substrate surface for up to twenty minutes, and preferably for up to ten minutes.

The reactive gas or vapor used may be selected according to its reactivity with the material targeted for removal from the substrate. Preferably, the reactive gas or vapor is capable of reacting chemically with a residue, such as a residue from an organic photoresist and/or a residue from a polymeric or fluoropolymeric etching agent, that may exist on or inside features of a substrate surface. Such a reaction may soften the material or residue, such that it is more easily removed from the substrate surface by physical means. Further, preferably, the reactive gas or vapor reacts with this targeted material to produce byproducts in a gaseous form, such that they may be removed from the chamber 12 via a flow of gas, such as nitrogen gas, through the chamber.

The reactivity of the reactive gas or vapor with the targeted material for cleaning may be enhanced or increased using an initiator or generator for generating free radical species or other reactive chemical species. Such an initiator or generator means may be or employ ultraviolet (UV) radiation, x-ray radiation, a corona-discharge, a plasma, a laser such as an excimer laser, UV light or other electromagnetic radiation by way of example, and would preferably be disposed in the chamber 12.

The chemical or reactive gas or vapor may include: a vapor, such as water vapor; a vapor of a liquid that has a high vapor pressure liquid, such as acetone, a mixture of ethanol and acetone, isopropyl alcohol, methanol, methyl formate, methyl iodide, ethyl bromide, and any combination thereof; a gas, such as ozone, hydrogen, nitrogen, a nitrogen oxide, nitrogen trifluoride, helium, argon, neon, sulfur trioxide, oxygen, fluorine, a fluorocarbon gas, and any combination thereof; or any combination of any such vapor, any such vapor of a high-vapor-pressure liquid, or any such gas, merely by way of example. Preferably, the reactive gas or vapor is any of the following: water vapor, a vapor of isopropyl alcohol, a vapor of a mixture of ethanol and acetone, a vapor of methanol, ozone, nitrogen trifluoride, sulfur trioxide, oxygen, fluorine, ozone, a fluorocarbon gas, and any combination of the foregoing.

Certain substrates 14 such as semiconductor wafers, comprise features with surface relief, such as trenches, that have high aspect ratios. Various cleaning materials, such as cryogenic particles, cannot get inside these features. Thus, according to the present invention, a reactive gas or vapor is supplied within the chamber 12, as described above, such that it contacts and diffuses into these features on surfaces 16, 18 of a substrate 14. The reactive gas or vapor then reacts chemically with residue, such as organic and/or polymeric residue from a previous process, that is targeted for removal from the substrate surface. The reaction produces a gaseous by-product that may be removed from the surface of the substrate by allowing a gas, such as nitrogen, to flow across the substrate surface and carry the by-product away. Following this cleaning process, the substrate may be subjected to a further cleaning, such as a cleaning under different conditions, and/or a cleaning via a different cleaning medium, such as a reactive liquid, as described previously, and/or a cryogenic cleaning medium, as further described herein. This secondary cleaning followed by rinse and dry can be done in the chemical station 84.

According to another embodiment of the present invention, the substrate may be cleaned in multiple chambers, including a low-pressure chamber of suitable “low” pressures and a chamber such as the chamber 12 previously described. The substrate 14 is placed in a low-pressure chamber and a reactive gas or vapor is introduced into the low-pressure chamber in a vicinity of the substrate. The nozzle 35 may be used for this purpose. A reaction between the reactive gas or vapor and a material that is contemplated or targeted for removal from a surface 16 of the substrate 14 is allowed to take place under suitable reaction conditions, such as a temperature of up to about 200° C. Following this cleaning process, the substrate 14 may be moved to another chamber, such as the chamber 12, for a further cleaning, such as a cleaning at a different pressure, such as atmospheric pressure, and/or a cleaning via a different cleaning medium, such as a reactive liquid, as described previously, and/or a cryogenic cleaning medium, as further described herein, or by exposing to electromagnetic radiation in conjunction with ozone. Preferably, the chambers are in communication with each other to facilitate movement of the wafer between and among the chambers.

When a reactive gas or vapor is used to clean the substrate 14, vapor may condense on the surface 16, of the substrate. Any such condensation may lower the Hammaker constant in the van der Waals force of interaction or the force of adhesion associated with particulate matter on the surface 16 of the substrate 14. Any such condensation may thus facilitate or enhance the removal of particulate matter from the surface 16 of the substrate 14, such as that associated with cryogenic cleaning processes. Thus, according to one aspect of the present invention, a reactive gas or vapor is selected to produce condensation on a surface of a substrate, and/or to lower the Hammaker constant or the force of interaction or the force of adhesion associated with particulate matter on a surface a substrate.

Processing of the surface 18 according to the invention may be similar to that described with respect to surface 16.

There are many types of materials that may be targeted for removal from the surfaces 16, 18 of the substrate 14. By way of example, in the cleaning of semiconductor wafers, such targeted material typically includes particulate material, ionic material, as well as organic, inorganic, or metal-organic residues or films that are associated with various steps of various microelectronic manufacturing processes, such as front-end-of-the-line (FEOL) and back-end-of-the line (BEOL) processes. Such ionic material, residues and films, as well as many such particulate materials, cannot be removed, or removed sufficiently, by purely physical mechanisms. This is particularly so for applications having very tight guidelines or standards of cleanliness, such as those involving precision cleaning.

Thus, according to the present invention, chemical and physical means are employed in combination to remove targeted material from a surface of a substrate. The reactive fluid or agent, whether in the form of a liquid, a gas or a vapor as described above, is used to clean a surface of a substrate via chemical means. In addition, a cryogenic fluid or agent is used to clean a surface of a substrate via predominantly physical means, as described herein. The reactive cleaning acts upon reactive materials chemically, thereby facilitating or enhancing their removal by the physical cleaning. The physical cleaning is effective as to the removal of non-reactive materials, as well as reactive materials that are subject and vulnerable to the reactive cleaning. The reactive cleaning and the cryogenic cleaning may be carried out simultaneously or sequentially or any combination thereof. By way of example, cryogenic cleaning at substrate temperature of up to 200° C. in cryogenic chamber 12 can be followed by fluid phase cleaning in the same chamber.

The wafer during the cryogenic cleaning operation is heated either conductively through the platen 25 in FIG. 3, or by hot gases from the nozzle 34 as in FIG. 2. By way of yet another example, a reactive vapor may be introduced to the targeted surface either simultaneously or sequentially with the cryogenic agent, and may be allowed to remain in contact with the targeted surface for up to about twenty minutes and at temperatures of up to about 200° C. The reactive and cryogenic cleaning processes may be used to remove targeted materials, whether ionic, homogeneous or inhomogeneous, from the surfaces of substrates.

As the invention relates to a combination of various chemical and physical cleaning processes, it will be understood that the invention may be used in combination with other chemical and physical cleaning processes. By way of example, the invention may be used in any suitable combination with a chemical, wet-cleaning process and a physical, plasma-cleaning process, such as a dual-frequency plasma process in which a downstream microwave plasma is used to generate chemical species for reaction with an undesirable or a foreign material and a radio frequency plasma is used to generate ions for bombardment of that material.

According to one embodiment of the present invention, a reactive agent or fluid and a cryogenic agent or fluid are delivered to a targeted surface using a particular nozzle configuration. The nozzle configuration comprises an arm to which at least two nozzles are connected. One nozzle 35 is used to deliver the chemical reactive agent, which may be in the form a vapor of a reactive liquid; and another nozzle 40 is used to deliver the cryogenic agent, which may be a cryogenic gas such as carbon dioxide, argon, and/or nitrogen, for example, to the targeted surface. Preferably, the nozzles are of a construction sufficient to deliver each of the two agents in a spray.

In the above-described nozzle configuration, the nozzle 35 that is used to deliver the reactive vapor may comprise a small bore, stainless steel or Teflon® tube, which may be from about a quarter to about a half of an inch in diameter. Alternatively, the nozzle that is used to deliver the reactive agent may comprise a nozzle in which a corona wire is disposed along its axis to initiate discharges in the vapor. In either case, the nozzle 35 that is used to deliver the reactive agent is preferably positioned at an angle of about 10 degrees to about 90 degrees relative to the targeted surface.

According to another embodiment of the invention, a reactive agent or fluid is delivered to a targeted surface using a particular showerhead or manifold configuration. Preferably, the showerhead is positioned above the targeted surface to promote or ensure substantially uniform coverage of that surface by the reactive agent. As mentioned previously, the reactive agent may be in the form of a vapor of a reactive fluid. Such a vapor may be sprayed onto the targeted surface for up to about twenty minutes, as is preferred, either continuously or intermittently. Preferably, a single type of vapor is sprayed in this manner, although different types of vapors may be sprayed in this manner, either simultaneously or sequentially, as desired or necessary for the removal of a particular material from the targeted surface.

In the above-described embodiment, the vapor and the targeted surface are preferably kept at about the same temperature during the delivery of the vapor to the targeted surface. The targeted surface may however be kept at a temperature below that of the vapor, as may be desired to initiate condensation of the vapor to form a thin film of liquid on the targeted surface. The vapor may be made reactive, or more reactive, via an initiator or generator of free radicals or reactive chemical species, as described above, as may be desired when a vapor is not sufficiently reactive for a given material targeted for removal from the targeted surface.

According to the present invention, reactive agents or fluids are used in combination with cryogenic agents or fluids, whether simultaneously or sequentially, to clean materials from surfaces and features of substrates. The materials may be cross-linked photoresists, post-etch residues, and particles, such as those of sub-micron dimensions, associated with the manufacturing of semiconductor wafers, whether on the surfaces of these wafers, or inside the features of these wafers, such as features having high aspect ratios, merely by way of example. Preferably, the reactive agents are employed initially to react with the material targeted for removal, and thereby compromise the targeted material such that it is more vulnerable to removal by physical means, and the cryogenic agents are employed subsequently to physically remove the targeted material. The invention thus provides a combination of chemical and physical cleaning means suitable for precision cleaning of semiconductor wafers and other surfaces from which cleaning of such contamination is required, all of which occurs in the same chamber or environment that the wafer is disposed.

With respect to the embodiments of FIGS. 1-4, it bears repeating that the application of a reactive chemical, cryogen and heating occurred in the same or a common chamber of that in which the substrate 14 is disposed.

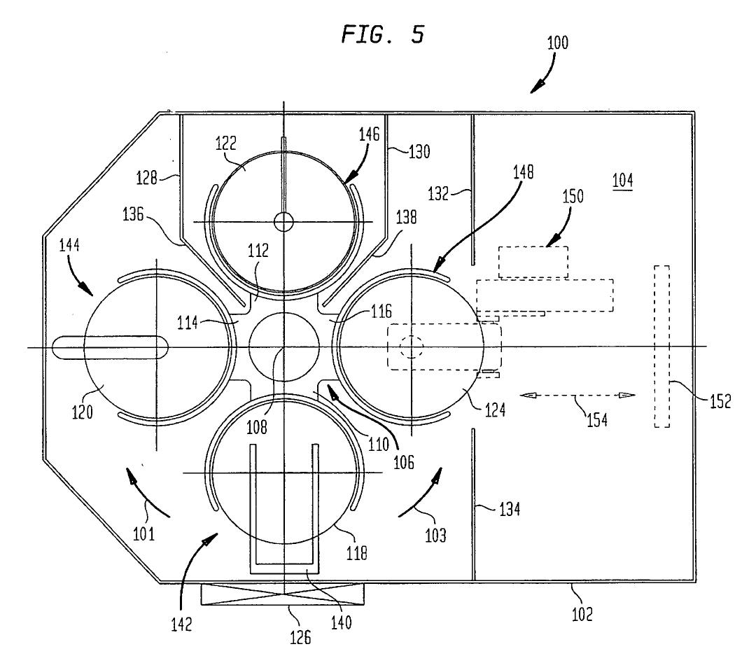

FIG. 5 discloses another embodiment of a system 100 according to the invention. As shown in FIG. 5, there is a treatment housing 100 having a wall 102 for housing a processing or cleaning chamber 104 therein. Disposed within the housing 100 is a carousel 106 mounted about a central pin or axis 108 around which the carousel 106 may be selectively rotated. Extending from a center of the carousel 106 is a plurality of arms 110, 112, 114, 116 (collectively referred to as “110-116”). Each of the arms 110-116 is provided with a corresponding wafer holder or platen 118, 120, 122, 124 (collectively referred to as “118-124”). The platens 118-124 are constructed and arranged to hold the wafers 14 deposited thereon for processing according to the invention.

The carousel 106 may be mounted in the chamber 12 of FIG. 1 and thereby subject to the airflow 20 and its advantages, or the housing may be stand alone and have provided therein at the chamber 104a related airflow to prevent particulate material from being redeposited on the wafer surface after it has already been removed.

A gate 126 is provided at the housing wall 102 to provide ingress and egress with respect to the chamber 104 for wafers entering the chamber 104 for processing, such as cleaning, and subsequent removal thereof after processing.

There may be disposed in the chamber a plurality of walls or partitions 128, 130, 132, 134, (collectively referred to as “128-134”) to provide for certain stations within the chamber 104. The wall 128 is provided with a slot 136, while the wall 130 is provided with a slot 138. Walls 132, 134 are spaced apart from each other as will be discussed below. The walls 128-134 may not even be necessary depending upon the chemical reactant used or if not used.

An arm or pins 140 is provided proximate to the gate 126 for use as described below.

The chamber 104 is provided with, essentially, four stations, any combination of which may be open and exposed to each other. A wafer load/unload station 142 is provided for coaction with the arm 140 to initiate the process with respect to wafers 14 introduced through the gate 126.

A heat station 144 is provided proximate to the load station 142 and, due to the nature of the processing which occurs at such station, it is not necessary to segregate or limit exposure between the stations 142, 144. Heating can occur from the platen at the heat station, or by convention currents and/or radiation.

The walls 128, 130 essentially define a chemical station 146 in the chamber 104. As mentioned above, each of the walls 128, 130 have corresponding slots 136, 138, respectively, formed therein which are sized and shaped to accommodate movement of the platens 118-124 into and out of the chemical station 146.

The walls 132, 134 are sufficiently spaced apart to permit the platens 118-124 access to a CO₂ station 148. A transport device 150 is provided to capture the wafer 14 disposed on the platen to remove it to a CO₂ station 148 for application of the CO₂ from the CO₂ nozzle assembly 152.

Operation of the embodiment of FIG. 4 will now described upon determination that one or a plurality of wafers 14 need to be processed to remove undesirable particulate material or layers thereof from the wafer 14. Accordingly, a transport assembly (not shown) provides the wafer to the gate 126 where the wafer 14 is permitted to enter through the gate 126 to be deposited on the lift arm 140. The lift arm 140 gently lowers the wafer onto the platen 118 for processing to commence.

Thereafter, the carousel 106 is rotated around the axial pin 108 to transport the platen 118 with the supported wafer 14 thereon to the heating station 144. (It should be understood that at this time, a subsequent delivery of another wafer 14 may also be introduced through the gate 126 to be deposited on the lift arm 140 so that processing can be in a continuous manner). The wafer 14 can be heated by means of convection, conduction or radiation and certainly in a manner similar to that which was described earlier in FIGS. 1-3. After sufficient preheating has occurred at the station 144, the carousel 106 is again rotated to pass the platen 118 through the slot 136 in the wall 128 so that the wafer can be processed in the chemical station 146. Chemical processing of the wafer 14 in the chemical station 146 can occur with the nozzle arrangements described above with respect to FIGS. 1-3.

After the chemical processing has occurred at the station 146, the carousel is again rotated to transport the platen 118 with the wafer 14 thereon through the slot 138 of the wall 130 to bring the wafer 14 to a position for CO₂ processing at the station 148.

It should be mentioned at this time that all of the wafer platens 118-124 are adapted for orienting the wafers thereon between horizontal and vertical positions. In that regard, when the platen 118 with the wafer 14 thereon reaches the position where the platen 124 is shown, which is a position outside the walls 132, 134, the wafer is captured by the transport assembly 150 and moved as indicated by arrow 154 to the CO₂ nozzle assembly 152. Such transport of the wafer 14 can be in the horizontal position as shown or the assembly 150 can orientate the wafer 114 up to 90° from the horizontal such that the wafer is vertically disposed with respect to the CO₂ nozzle assembly 152. Cleaning can then occur similar to that which was discussed with respect to FIGS. 1 and 2.

After processing at the CO₂ station 148, the transport assembly 150 returns the wafer 14 back to the platen 118, and rotation of the carousel 106 proceeds to transport the wafer to the lift arm 140 for removal through the gate 126, and to also provide for a following platen (such as the platen 122) to be positioned for CO₂ processing as discussed above.

The carousel 106 is constructed and arranged for selective rotation between and among the stations in any sequence. Using the platen 118 as an example, after the wafer is loaded onto the platen at the station 142, the carousel can be rotated clockwise to bring the platen 118 to the station 144, or rotated counterclockwise to bring the platen 118 to the station 148 for cryogen processing. In addition, the arm 140 may be constructed and arranged to be deployed or extended to and among the different platen s 118-124 to facilitate wafer processing and cleaning.

It is also preferred that at least with respect to station 148, any airflow at such station is substantially reduced if not eliminated to preserve the effectiveness of the cryogen delivered to the wafer for this particular embodiment.

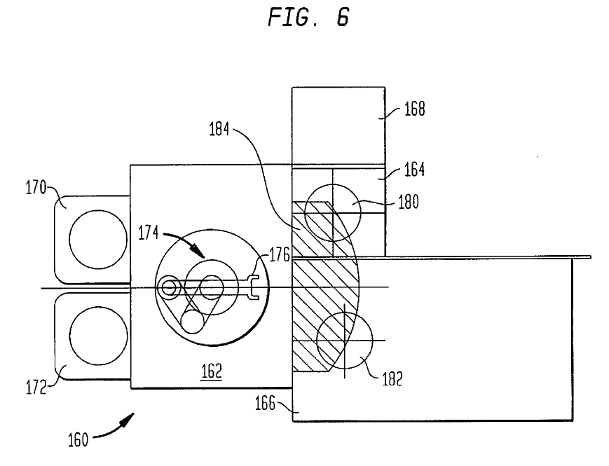

FIG. 6 discloses a modular arrangement with respect to a heating station and a cryogen (CO₂) station for processing of the wafers. A fluid chemical reactant is not necessarily used in this embodiment. Referring to FIG. 6, there is provided an assembly 160 which includes a load/unload unit 162, a preheater station unit 164 and a CO₂ or other cryogen processing station 166. A chemical station 168 may also be provided.

The load/unload station (“load station”) 162 is constructed and arranged to receive one or a plurality of front opening unified pods (or “FOUP”s). The pods as shown may include a dirty FOUP 170 and a clean FOUP 172. The pods 170, 172 function as cartridges for dirty and clean wafers.

The dirty pod 170 includes at least one and more than likely a plurality or multiplicity of wafers which have been processed and are therefore determined to be “dirty”. Hence the name “dirty FOUP”. The FOUP 170 is loaded into the apparatus 162 which is adapted to open the FOUP 170. A robot assembly 174 includes an arm 176 to transport the dirty wafers in the FOUP 170 to the preheater station 178 and onto a platen 180 for preheating. Preheating can occur by any one of the processes as described above with respect to FIGS. 1-3.

After the necessary amount of time has elapsed for heating of the wafer, the robot arm 176 retrieves the wafer from the preheater station 164 and delivers the wafer to the CO₂ processing station 166 where the wafer is deposited on a platen 180 for cryogen processing. CO₂ processing of the wafer may be by use of the nozzles and wafer orientation above described with respect to FIGS. 1-3.

Thereafter, the robot arm 176 can withdraw the wafer from cryogen processing and return it to the clean FOUP 172 where one or a plurality of cleaned wafers are stored prior to the FOUP 172 being removed for subsequent processing or use.

The range of movement of the robot arm 176 is shown generally at 184. Of course, if the chemical station 168 is used, such range is extended for the arm 176 to operate in a manner similar to the operation with respect to the stations 164, 166. Each of the status 164, 166, and 168 if used, may be separate modular units adapted for releasable engagement to each other and the unit 162 for coaction therewith and the robot assembly 174. Each of the stations will have access ports for the robot arm 176, such access ports in registration with the range of movement of the arm 176 and preferably in the same plane as that of the arm's 176 movement. In this manner of construction, the unit 162 can be disposed to coact with different processing stations treating or cleaning different types of wafer.

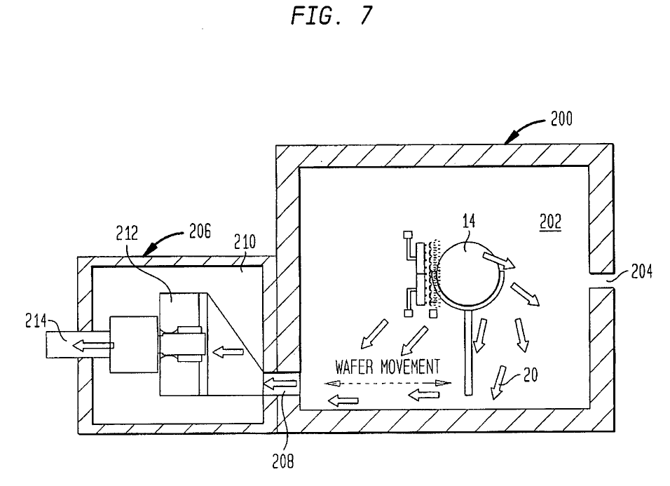

FIG. 7 discloses an embodiment of the system according to the invention wherein a pressure differential assembly is in communication with the processing chamber of the embodiment of FIGS. 1-6. For example, the system of FIGS. 1 and 2 can be either at atmospheric pressure or connected to provide a vacuum for the system. That is, the cryogenic gases used in the chamber under vacuum could be CO₂, argon, nitrogen or other suitable cryogenic gases.

Referring to FIG. 7, a system 200 is provided having a chamber 202 therein for processing of wafers 14. The elements of the system 200 may be similar to that which are described above with respect to FIG. 1-6. A gate or port 204 is provided for access to the chamber 202 of the system 200. The gate 204 is in communication with a robotic arm or other conveying apparatus (not shown) for delivering the wafers 14 to the system 200.

A pressure differential assembly 206 is in communication with the system 200 by virtue of a passage 208 providing for communication between the chamber 202 and a chamber 210 of the pumping assembly 206. A pump 212 is disposed within the chamber 210 for drawing a vacuum in the and expelling atmosphere from chamber 202 through an exhaust 214.

The system embodiments of the invention described herein enable any photoresist on a substrate to be cleaned, as well as the substrate.

The present invention is advantageous in that it facilitates the effective cleaning of targeted surfaces. In many applications, a targeted surface cannot be cleaned effectively by a cryogenic gas, given its relatively low chemical activity and its limitations as to the removal of small particles, such as those of submicron dimensions, and various polymeric residues. The use of chemically reactive agents and physically disruptive cryogenic agents, in accordance with the present invention, provides for the effective removal of such small particles and polymeric residues and for the enhanced cleaning of targeted surfaces and features of substrates such as used in semiconductor wafers. Advantageously, the cleaning process of the present invention does not require drying the substrate at the end of the process, as is typical in conventional wet-cleaning processes.

It will be understood that the embodiments described herein are merely exemplary, and that a person skilled in the art may make many modifications and variations of same without departing from the spirit and scope of the invention. All such modifications and variations are intended to be included within the scope of the invention as defined in the claims herein.

What is claimed is:

1. An apparatus for treating a substrate, comprising:
a chamber; and delivery means for heat and at least one selected from the group consisting of a cryogen, a fluid reactant and combinations thereof, disposed in the chamber for delivering treatment to at least one surface of the substrate.

2. The apparatus according to claim 1, further comprising air flow in the chamber substantially parallel to the at least one surface of the substrate to be treated.

3. The apparatus according to claim 1, further comprising pressure differential means in communication with the chamber for providing a vacuum in the chamber.

4. The apparatus according to claim 1, further comprising support means for supporting the substrate in the chamber.

5. The apparatus according to claim 4, wherein the support means comprises a platen.

6. The apparatus according to claim 4, wherein the support means is rotatable.

7. The apparatus according to claim 4, wherein at least one of the support means and the delivery means is constructed and arranged in the chamber for movement with respect to the other.

8. The apparatus according to claim 4, wherein the support means is movable in the chamber for exposing the at least one surface to treatment.

9. The apparatus according to claim 1, wherein the delivery means comprises a plurality of nozzles for delivery of the heat, the cryogen and the fluid reactant.

10. The apparatus according to claim 1, wherein the delivery means comprises a plurality of nozzles constructed and arranged in the chamber for movement with respect to the substrate.

11. The apparatus according to claim 1, further comprising rinsing means for rinsing the at least one surface of the substrate.

12. The apparatus according to claim 11, further comprising drying means for drying the at least one surface of the substrate.

13. The apparatus according to claim 1, further comprising filter means in communication with the chamber for filtering an atmosphere of the chamber.

14. The apparatus according to claim 1, wherein the heat provided by the delivery means is selected from the group consisting of nitrogen, clean dry air, CO₂, argon, helium, oxygen, and combinations thereof.

15. The apparatus according to claim 1, wherein the cryogen is selected from the group consisting of a cryogenic agent, a cryogenic fluid, carbon dioxide, argon, nitrogen, and combinations thereof.

16. The apparatus according to claim 1, wherein the fluid reactant is selected from the group consisting of polar solvents, non-polar solvents, and combinations thereof.

17. The apparatus according to claim 1, wherein the fluid reactant is selected from the group consisting of a reactive gas, a reactive vapor, a reactive vapor of a reactive liquid, and combinations thereof.

18. The apparatus according to claim 1, wherein the fluid reactant is selected from the group consisting of a vapor, such as water vapor, a vapor of a liquid that has a high vapor pressure, and combinations thereof; a liquid such as acetone, ethanol, a mixture of ethanol and acetone, isopropyl alcohol, methanol, methyl formate, methyl iodide, ethyl bromide, acetonitrile, ethylchloride, pyrrolidine, dimethylsulfoxide, and combinations thereof; a gas such as ozone, hydrogen, nitrogen, a nitrogen oxide, nitrogen trifluoride, helium, argon, neon, sulfur trioxide, oxygen, fluorine, a fluorocarbon gas, and combinations thereof; and combinations of said vapor, said vapor of a high vapor pressure liquid, and any such gas; water vapor; a vapor of isopropyl alcohol; a vapor of a mixture of ethanol and acetone; a vapor of methanol, ozone, nitrogen trifluoride, sulfur trioxide, oxygen, fluorine, ozone; a fluorocarbon gas, and combinations thereof.

19. The apparatus according to claim 1, further comprising mitigation means disposed in the chamber for mitigating electrostatic charges in at least one of the chamber, the delivery means and the substrate.

20. The apparatus according to claim 19, wherein the mitigation means comprises means for ionization.

21. The apparatus according to claim 1, further comprising generating means for generating electromagnetic radiation for coaction with the fluid reactant in the chamber.

22. The apparatus according to claim 9, wherein the plurality of nozzles are nested adjacent each other for concurrent movement.

23. The apparatus according to claim 9, wherein the plurality of nozzles are constructed and arranged for movement separate from each other.

24. The apparatus according to claim 4, wherein the support means is constructed and arranged to orient the substrate in a select position with respect to the delivery means.

25. The apparatus according to claim 4, wherein the support means comprises a heating element for heating the substrate.

26. The apparatus according to claim 25, wherein the heating element is integral with the substrate.

27. The apparatus according to claim 1, wherein the chamber comprises a plurality of stations in communication with each other to provide said chamber.

28. The apparatus according to claim 27, wherein each one of the plurality of stations is in a separate unit adapted for coaction with at least one other of the plurality of stations.

29. The apparatus according to claim 27, further comprising a transport assembly for transporting the substrate between and among the plurality of stations.

30. The apparatus according to claim 27, further comprising support means adapted to support and move the substrate between and among the plurality of stations in the chamber.

31. The apparatus according to claim 29, further comprising a control assembly disposed for coaction with the transport assembly to control transport of the substrate to and from the transport assembly.

32. The apparatus according to claim 31, wherein the control assembly comprises an inlet for the wafer to be introduced to the transport assembly, and an outlet for the wafer treated to be removed from the transport assembly.

33. The apparatus according to claim 1, further comprising support means disposed in the chamber to support and position the substrate with respect to the delivery means.

34. An apparatus for treating a substrate, comprising delivery means for heat, a cryogen and a fluid reactant, the delivery means disposed in a chamber in which the substrate is disposed for treatment to at least one surface of the substrate.

35. An apparatus for treating a substrate, comprising delivery means for heat and a cryogen, the delivery means disposed in a chamber in which the substrate is disposed for treatment to at least one surface of the substrate.

36. An apparatus for treating a substrate, comprising delivery means for heat and a fluid reactant, the delivery means disposed in a chamber in which the substrate is disposed for treatment to at least one surface of the substrate.

37. A method for treating a substrate, comprising disposing the substrate in a chamber; and providing heat and at least one selected from the group consisting of a cryogen, a fluid reactant and combinations thereof in said chamber to at least one surface of the substrate to be treated.

38. The method according to claim 37, further comprising directing a flow of air substantially parallel to the at least one surface of the substrate.

39. The method according to claim 37, further comprising reducing pressure in the chamber to be less than pressure external to the chamber.

40. The method according to claim 37, further comprising supporting the substrate in the chamber to be at a select orientation for being treated in the chamber.

41. The method according to claim 37, further comprising mitigating electrostatic charges in at least one of the chamber and the substrate.

42. The method according to claim 37, further comprising providing electromagnetic radiation to the fluid reactant to enhance reactivity of said fluid reactant with the substrate.

43. The method according to claim 37, wherein the at least one surface treated is cleaned.

44. The method according to claim 37, further comprising rinsing the at least one surface treated.

45. The method according to 44, further comprising drying the surface rinsed.

46. The method according to claim 44, wherein rinsing is with one selected from the group consisting of deionized water, organic solvents, and combinations thereof.

47. The method according to claim 37, further comprising filtering an atmosphere of the chamber.

48. The method according to claim 37, further comprising generating electromagnet radiation for coaction with the fluid reactant.

49. The method according to claim 37, further comprising moving the substrate in the chamber for treatment to the substrate.

50. The method according to claim 37, wherein the chamber comprises a plurality of separate stations in communication with each other for providing the chamber.

51. A method for treating a substrate, comprising disposing the substrate in a chamber; and providing heat, a cryogen and a fluid reactant in said chamber for treatment to at least one surface of the substrate to be treated.

52. A method for treating a substrate comprising disposing the substrate in a chamber; and providing heat and a cryogen in the chamber in which the substrate is disposed for treatment to at least one surface of the substrate.

53. A method for treating a substrate, comprising disposing the substrate in a chamber; and providing heat and a fluid reactant disposed in the chamber in which the substrate is disposed for treatment to at least one surface of the substrate.
